(19) United States
(12) Patent Application Publication
(10) Pub. No.: US 2026/0340228 A1
(43) Pub. Date: Oct. 29, 2026

(54) AUTOMATIC HISTORY MATCHING METHOD AND APPARATUS BASED ON RU-NET AND LSTM NEURAL NETWORK MODELS

(71) Applicant: PETROCHINA COMPANY LIMITED, Beijing (CN)

(72) Inventors: Jiqun ZHANG, Beijing (CN); Deli JIA, Beijing (CN); Xin LI, Beijing (CN); Junhua CHANG, Beijing (CN); Xianing LI, Beijing (CN); Li WU, Beijing (CN); Liming WANG, Beijing (CN); Lining CUI, Beijing (CN); Yang ZHANG, Beijing (CN); Quanbin WANG, Beijing (CN)

(73) Assignee: PETROCHINA COMPANY LIMITED, Beijing (CN)

(21) Appl. No.: 19/106,287

(22) PCT Filed: Aug. 11, 2023
(86) PCT No.: PCT/CN2023/112465

§ 371 Date: Feb. 25, 2025

(30) Foreign Application Priority Data
Aug. 31, 2022 (CN) 202211055980.6

(51) Int. Cl. G06F 30/27; G06N 3/0442

(52) U.S. Cl. CPC G06F 30/27; G06N 3/0442

(57) ABSTRACT

An automatic history fitting method based on RU-Net and LSTM neural network models includes: performing mesh generation of a reservoir property model by means of well zoning; constructing a data training set; processing sample data in the data training set; training, based on the processed sample data, a prediction model for predicting reservoir pressure, saturation distribution and injection-production performance; and performing, based on the prediction model, parameter estimation of a reservoir geological model by means of an intelligent optimization algorithm. The automatic history fitting method have the advantages that the data processing volume is small, the research cycle is greatly shortened, the injection-production performance of reservoirs can be accurately predicted, the precision of reservoir heterogeneity characterization is significantly improved, the uncertainty of remaining oil distribution is reduced, and accurate description and prediction for the whole life cycle of reservoir development are achieved.

### FIELD OF THE INVENTION

The present disclosure relates to the technical field of oil exploitation, in particular to an automatic history fitting method based on RU-Net and LSTM neural network models, an automatic history fitting apparatus based on RU-Net and LSTM neural network models, an electronic device, and a machine-readable storage medium.

### BACKGROUND OF THE INVENTION

Reservoir data history fitting is an extremely important part of the reservoir simulation process. For manual history fitting, reservoir engineers are required to have rich experience, moreover, it takes a lot of time to adjust parameters repeatedly in the process, the research cycle is long, limitations exist, and the uncertainty of prediction for reservoir development indexes is high. Therefore, automatic history fitting methods have become a research hotspot in the field of reservoir engineering in recent years. The automatic history fitting methods may be roughly divided into two ideas: being based on model space inversion and being based on data space inversion.

When a model space inversion algorithm is used for fitting, a random maximum likelihood estimation method is one of the sampling methods. However, the process of a sampling-based method is extremely time-consuming, so the method is not applicable to large-scale problems. Moreover, multiple restart operations are required in the fitting process, and assuming that model parameters have a linear relationship with the flow response during each update, there are some errors when dealing with nonlinear problems. An ensemble-based ensemble smoothing algorithm no longer needs restart of a simulator, and a one-time global update is performed on the model parameters, so that the purpose of being faster than Kalman filtering is achieved. However, since the model parameters are updated only through one iteration in the ensemble smoothing algorithm, the insufficient degree of fitting among the problems about reservoir history fitting is caused. Therefore, an ensemble smoothing algorithm under multiple data assimilation was developed, which currently has better application in dealing with the problems about reservoir history fitting. For natural fractured reservoirs, history fitting research is carried out, but only a single posteriori model is generated by a method adopted, so the uncertainty of prediction for reservoir indexes may not be effectively reduced. At present, it is difficult to directly apply the method to the history fitting problem of actual fractured reservoirs.

When a data space inversion algorithm is used, in the prior art, pollutant concentration data may be predicted through an uncertainty quantification method based on prediction focus analysis. On this basis, dimension reduction is performed on data and prediction variables by using a standard function component analysis method, thus the problems in prediction focus analysis are solved. The method has been applied to the reservoir development and pollutant concentration prediction, but the method may not effectively reduce the uncertainty of prediction for oilfield development indexes, and may not effectively guide management and decision-making of oilfield development or carry out quantitative analysis of uncertainty.

### SUMMARY OF THE INVENTION

An objective of the embodiments of the present disclosure is to provide an automatic history fitting method and apparatus based on RU-Net and LSTM neural network models. The automatic history fitting method and apparatus based on the RU-Net and LSTM neural network models are used to solve the above-mentioned problems that for manual history fitting, reservoir engineers are required to have rich experience, moreover, it takes a lot of time to adjust parameters repeatedly in the process, the research cycle is long, limitations exist, and the uncertainty of prediction for reservoir development indexes is high.

In order to achieve the above objective, an embodiment of the present disclosure provides an automatic history fitting method based on RU-Net and LSTM neural network models. The method includes:
step 1, performing mesh partitioning of a reservoir property model by means of well zoning: generating, based on well location coordinates in the reservoir property model, a plurality of well control units bounded by a well control range of a single well reservoir;
step 2, constructing a data training set, including:
step 21, for each well control unit:
calculating an average value of each type of static parameters in all meshes included in the well control unit to obtain multiple types of average static parameters of the well control unit, and using the multiple types of average static parameters of all the well control units as basic static data;
step 22, performing parameter perturbation on the basic static data to generate a plurality of parallel examples as input data of the data training set; and
step 23, performing forward modeling on the plurality of generated parallel examples respectively through numerical modeling of the reservoir to obtain reservoir pressure, saturation distribution and injection-production performance as output data of the data training set;
step 3, processing sample data in the data training set;
step 4, training, based on the processed sample data, prediction models for predicting the reservoir pressure, the saturation distribution and the injection-production performance; and
step 5, performing, based on the prediction models, parameter estimation of a reservoir geological model by means of an intelligent optimization algorithm.

Optionally, wherein step 3 comprises:
step 31, cleaning the sample data based on a production history of a producing well, production performance of a peripheral well and reservoir physical property distribution;
step 32, rejecting outliers in the sample data; and
step 33, performing normalization processing on the sample data.

Optionally, wherein step 33 comprises:
step 331, for pressure field data in the sample data:
calculating an average value of pressure fields of all time steps in the sample data;
subtracting the average value of the pressure fields of all the time steps from pressure field data of each time step to obtain a pressure difference field; and
performing normalization processing on the pressure difference field by using a min-max normalization algorithm; and
step 332, performing normalization processing on all other data in the sample data except the pressure fields by using the min-max normalization algorithm.

Optionally, wherein step 4 comprises:
step 41, training, based on the processed sample data and a recursive full convolutional neural network, to obtain a pressure field prediction model and a saturation field prediction model; and
step 42, training, based on the processed sample data and a long short-term memory neural network, to obtain an injection-production performance prediction model.

Optionally, wherein step 5 comprises:
step 51, acquiring the reservoir geological model, reservoir well control parameters and actual injection-production performance;
step 52, inputting the reservoir geological model into the pressure field prediction model to obtain a pressure field of a reservoir, and inputting the reservoir geological model into the saturation field prediction model to obtain a saturation field of the reservoir;
step 53, inputting the pressure field, the saturation field, and the reservoir well control parameters into the injection-production performance prediction model to obtain predicted injection-production performance;
step 54, using a difference between the predicted injection-production performance and the actual injection-production performance as a loss function;
step 55, performing stochastic optimization on parameters of the reservoir geological model by using a random maximum likelihood estimation algorithm and a mesh adaptive direct search algorithm; and
step 56, updating the reservoir geological model of a reservoir region based on parameters corresponding to the minimization of the loss function.

An embodiment of the present disclosure further provides an automatic history fitting apparatus based on RU-Net and LSTM neural network models. The apparatus includes:
a mesh partitioning module configured to perform mesh partitioning of a reservoir property model by means of well zoning: generating, based on well location coordinates in the reservoir property model, a plurality of well control units bounded by a well control range of a single well reservoir;
a data set construction module configured to construct a data training set, including:
for each well control unit:
calculating an average value of each type of static parameters in all meshes included in the well control unit to obtain multiple types of average static parameters of the well control unit, and using the multiple types of average static parameters of all the well control units as basic static data;
performing parameter perturbation on the basic static data to generate a plurality of parallel examples as input data of the data training set; and
performing forward modeling on the plurality of generated parallel examples respectively through numerical modeling of the reservoir to obtain reservoir pressure, saturation distribution and injection-production performance as output data of the data training set;
a data processing module configured to process sample data in the data training set;
a model building module configured to train, based on the processed sample data, prediction models for predicting the pressure, the saturation distribution and the injection-production performance; and
a parameter estimation module configured to perform, based on the prediction models, parameter estimation of a reservoir geological model by means of an intelligent optimization algorithm.

Optionally, wherein the data processing module is specifically configured to:
clean the sample data based on a production history of a producing well, production performance of a peripheral well, and reservoir physical property distribution;
reject outliers in the sample data; and
perform normalization processing on the sample data.

Optionally, wherein the model building module is specifically configured to:
train, based on the processed sample data and a recursive full convolutional neural network, to obtain a pressure field prediction model and a saturation field prediction model; and
train, based on the processed sample data and a long short-term memory neural network, to obtain an injection-production performance prediction model.

In another aspect, the present disclosure provides an electronic device. The electronic device includes a memory, a processor, and a computer program stored in the memory and able to run on the processor, and the processor, when executing the computer program, implements the automatic history fitting method based on RU-Net and LSTM neural network models described above.

In another aspect, the present disclosure provides a machine-readable storage medium. The machine-readable storage medium stores instructions, and the instructions are used to cause a machine to execute the automatic history fitting method based on RU-Net and LSTM neural network models described above.

According to this technical solution, mesh partitioning is performed by means of well zoning, the data training set is constructed, then the sample data in the data training set is processed to obtain accurate sample data, then the prediction models for predicting the reservoir pressure, the saturation distribution and the injection-production performance is trained based on the processed sample data, and finally parameter estimation of the reservoir geological model is performed based on the prediction model by means of the intelligent optimization algorithm. By means of the above method, the defects of the manual history fitting method, such as relying on the experience of engineers, long research cycle, and limitations, can be overcome, the research cycle can be greatly shortened, the prediction accuracy of dynamic data can be improved, the uncertainty of prediction for the reservoir development indexes can be greatly reduced, the accurate description and prediction for the whole life cycle of reservoir development can be achieved, the precision of reservoir heterogeneity characterization can be significantly improved, and the uncertainty of remaining oil distribution can be reduced.

Other features and advantages of the embodiments of the present disclosure will be described in detail in the following detailed description.

### BRIEF DESCRIPTION OF DRAWINGS

The accompanying drawings, which are included to provide a further understanding of the embodiments of the present disclosure and constitute a part of the specification, serve to explain the embodiments of the present disclosure together with the detailed description below, but are not to be construed as limiting the embodiments of the present disclosure. In the figures:

FIG. 1 is a flow diagram of an automatic history fitting method based on RU-Net and LSTM neural network models provided by the present disclosure;

FIG. 2 is a schematic diagram of a well control unit provided by the present disclosure;

FIG. 3 is a schematic diagram of changes of water content indexes of well in different examples provided by the present disclosure;

FIG. 4 is a schematic diagram of a comparison between predicted injection-production performance and actual injection-production performance provided by the present disclosure; and

FIG. 5 is a schematic structural diagram of an automatic history fitting apparatus based on RU-Net and LSTM neural network models provided by the present disclosure.

### DESCRIPTION OF REFERENCE NUMERALS

10—Mesh partitioning module; 20—Data set construction module;
30—Data processing module; 40—Model building module; and
50—Parameter estimation module.

### DETAILED DESCRIPTION OF THE EMBODIMENTS

The specific implementations of the embodiments of the present disclosure are described in detail below with reference to the accompanying drawings. It is to be understood that the specific implementations described herein are merely illustrative and explanatory of the embodiments of the present disclosure, and are not restrictive of the embodiments of the present disclosure.

In the embodiments of the present disclosure, the terms such as “first”, “second” and “third” are only used to distinguish descriptions, and cannot be understood as indicating or implying relative importance.

In addition, terms such as “approximately” and “basically” are intended to indicate that the relevant content does not require absolute precision, but can have a certain deviation. For example, “approximately equal” does not only mean absolute equality, because in the actual production and operation process, it is difficult to achieve absolute “equality”, and there is generally a certain deviation. Therefore, in addition to absolute equality, “approximately equal” also includes the above situation where there is a certain deviation. By way of example, in other cases, unless otherwise specified, terms such as “approximately” and “basically” have meanings similar to the above.

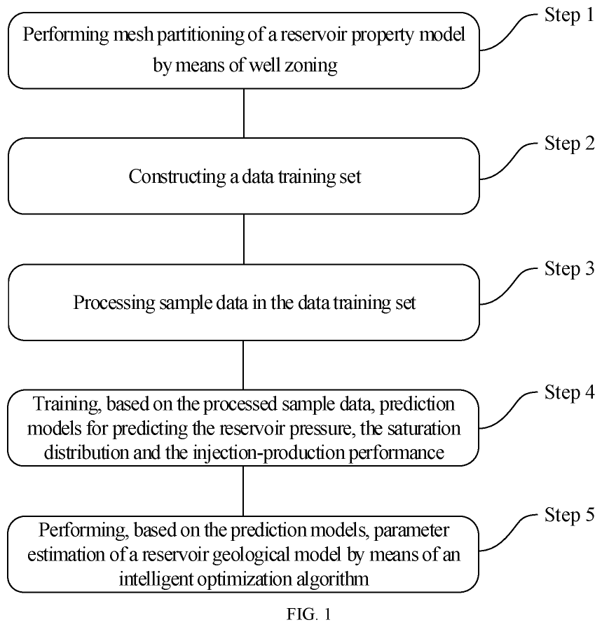

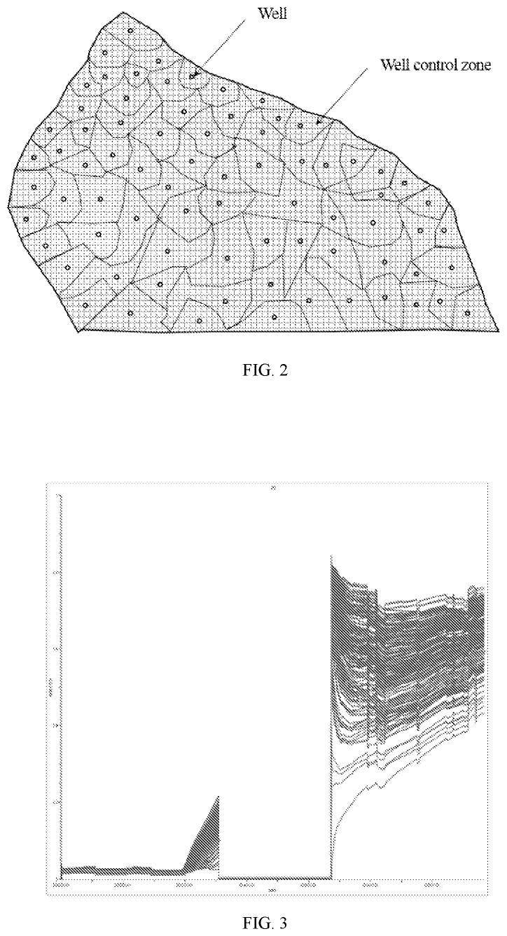

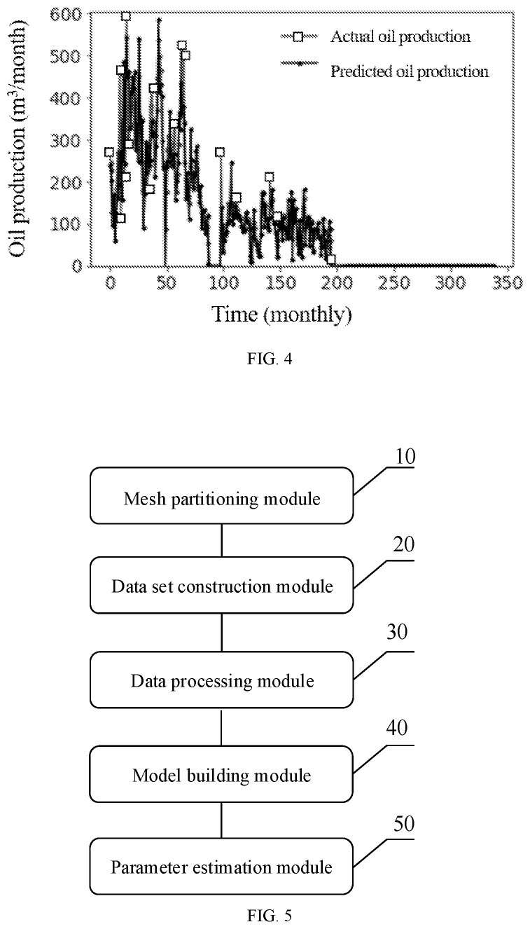

FIG. 1 is a flow diagram of an automatic history fitting method based on RU-Net and LSTM neural network models provided by the present disclosure; FIG. 2 is a schematic diagram of a well control unit provided by the present disclosure; FIG. 3 is a schematic diagram of changes of water content indexes of well in different examples provided by the present disclosure; FIG. 4 is a schematic diagram of a comparison between predicted injection-production performance and actual injection-production performance provided by the present disclosure; and FIG. 5 is a schematic structural diagram of an automatic history fitting apparatus based on RU-Net and LSTM neural network models provided by the present disclosure.

### Embodiment 1

As shown in FIG. 1, an embodiment of the present disclosure provides an automatic history fitting method based on RU-Net and LSTM neural network models. The method includes the following steps.

In step 1, mesh partitioning of a reservoir property model is performed by means of well zoning.

Specifically, step 1 specifically includes: a plurality of well control units bounded by a well control range of a single well reservoir are generated based on well location coordinates in the reservoir property model. The reservoir property model is constructed using the steps of conventional geological modeling, that is, a reservoir tectonic model is built first, and then the reservoir property model is built, which is readily available to those skilled in the art, and will not be repeated herein.

In addition, as shown in FIG. 2, since a complete reservoir property model usually includes at least millions of meshes, the complete reservoir property model has a large number of property parameters, so if data of each mesh is used as input data for calculation, a curse of dimensionality may be generated, the data volume is huge, the data processing time is too long accordingly, and the efficiency of data processing is reduced. In this implementation, taking single reservoir wells as an example: with each well as a center, mesh partitioning is performed on the reservoir property model, the reservoir property model is divided into a plurality of well control units, each well control unit has one well and a plurality of meshes, and data of each well control unit is used as input data for calculation, so that the data processing volume is reduced.

More specifically, in this implementation, with each well as a center, the well control unit for each well is determined in a geological model using a Voronoi algorithm. The Voronoi algorithm, also known as a Tyson polygon or Dirichlet diagram, consists of a set of consecutive polygons consisting of perpendicular bisectors of straight lines connecting two neighboring points. N points, distinct in the plane, divide the plane according to the principle of nearest neighbor, and each point is associated with the nearest neighbor region thereof. A Delaunay triangle is a triangle formed by connecting associated points that share an edge with neighboring Voronoi polygons. The center of the outer circle of the Delaunay triangle is a vertex of the Voronoi polygon associated with the triangle.

In step 2, a data training set is constructed.

This step specifically includes: step 21, for each well control unit:
an average value of each type of static parameters in all meshes included in the well control unit is calculated to obtain multiple types of average static parameters of the well control unit, and the multiple types of average static parameters of all the well control units are used as basic static data;
step 22, parameter perturbation is performed on the basic static data to generate a plurality of parallel examples as input data of the data training set; and
step 23, forward modeling is performed on the plurality of generated parallel examples respectively through numerical modeling of the reservoir to obtain reservoir pressure, saturation distribution and injection-production performance as output data of the data training set.

More specifically, after mesh partitioning is performed in step 1, for each well control unit, the average value of all the static parameters of the same type in the well control unit is calculated, and the average value is used as the static parameter of this type in the well control unit; similarly, the same processing method is adopted for the other types of static parameters, so that there is only one static parameter of each type in each well control unit; and finally, the static parameters of each type in each well control unit are merged as the complete basic static data. As shown in FIG. 2, by means of the processing method described above, the data processing volume can be greatly reduced, and during subsequent training and calculation, the processing efficiency is improved and the processing time is shortened.

In this implementation, the static parameters include: permeability, porosity, thickness, initial oil saturation, initial pressure, etc. Therefore, each well control unit has the corresponding permeability, porosity, thickness, initial oil saturation, and initial pressure. If one million meshes and two hundred wells, which are single reservoir wells, are provided in a certain reservoir region, and each mesh corresponds to one type of parameters, the reservoir region has a total of one million permeabilities, one million porosities, one million thicknesses, one million initial oil saturations and one million initial pressures. If calculation is performed based on the above data, the data volume is huge. Therefore, parameter optimization is required to achieve the effect of dimension reduction. Mesh partitioning is performed with each of the two hundred wells as a center, to obtain two hundred well control units finally; the permeability, porosity, thickness, water body, fault, structure, initial oil saturation and initial pressure of each well control unit are averaged to obtain the static parameters corresponding to each well control unit (two hundred well control units in total); and then the data in the two hundred well control units is merged as the basic static data of the reservoir region, so one million data is downgraded to two hundred data finally, that is, the basic static data of a whole reservoir has only two hundred permeabilities, two hundred porosities, two hundred thicknesses, two hundred initial oil saturations and two hundred initial pressures. In addition, the well control units have different areas, so the quantity of meshes in each well control unit is also different.

In order to ensure the accuracy of the model, the model is required to be trained by using a large amount of training data. Therefore, after the basic static data is obtained, parameter perturbation is performed within the corresponding preset range based on the basic static data to obtain a large number of parallel examples by way of zooming in and zooming out at preset multiples, etc., as shown in FIG. 3, and then forward modeling is performed on a large amount of parallel example data through numerical modeling of the reservoir to obtain simulation results corresponding to different input data combinations, i.e., the pressure field, saturation field and injection-production performance of the reservoir, and accordingly the data training set is constructed.

In step 3, sample data in the data training set is processed.

This step specifically includes: step 31, the sample data is cleaned based on a production history of a producing well, production performance of a peripheral well, and reservoir physical property distribution;
step 32, outliers in the sample data are rejected; and
step 33, normalization processing is performed on the sample data.

This step further includes: step 331, for pressure field data in the sample data:
an average value of pressure fields of all time steps in the sample data is calculated;
the average value of the pressure fields of all the time steps is subtracted from pressure field data of each time step to obtain a pressure difference field; and
normalization processing is performed on the pressure difference field by using a min-max normalization algorithm; and
step 332, normalization processing is performed on all other data in the sample data except the pressure fields by using the min-max normalization algorithm.

More specifically, after the well control units are generated, the operation of cleaning the sample data is carried out based on the production history of the producing well, the injection-production performance of the peripheral well, the reservoir physical property distribution, etc., so valid data is retained, invalid data is rejected, missing data is estimated, and dirty data is converted into data that meets the quality requirements; the operation of outlier detection for the sample data is carried out, the causes of the outliers are analyzed, and early warning is made in the case of abnormal data; and the operation of normalization processing of the sample data is carried out to prepare data for subsequent big data and machine learning algorithms. In addition to the pressure field data, the permeability, porosity, thickness, initial oil saturation and so on are subjected to normalization processing directly using the min-max normalization algorithm. For initial pressure data, an average pressure value of initial pressure of each time step in each well control unit is obtained, the average pressure value is subtracted from the pressure field data of each time step to obtain the pressure difference field, and then the pressure difference field of each time step in the training set is normalized using the min-max normalization algorithm, so that original pressure field data is de-trended.

In step 4, prediction models for predicting the reservoir pressure, the saturation distribution and the injection-production performance is trained based on the processed sample data.

This step specifically includes: step 41, training is performed based on the processed sample data and a recursive full convolutional neural network (RU-Net) to obtain a pressure field prediction model and a saturation field prediction model; and
step 42, training is performed based on the processed sample data and a long short-term memory (LSTM) neural network to obtain an injection-production performance prediction model.

More specifically, the sample data in the data training set is divided into a training set, a validation set, and a test set in a ratio of 8:1:1. The training set is used to train model parameters, the validation set is used to adjust neural network hyper-parameters, and a model effect is evaluated by the test set. In the training process, an L2 paradigm is used for loss function regular terms of the pressure field prediction model and the saturation field prediction model, and an L1 paradigm is used for loss function regular terms of the injection-production performance prediction model.

Moreover, the processed data training set may be divided into first training data sets for training the field prediction models and a second training data set for training the injection-production performance prediction model. The first training data sets are used as an input to the recursive full convolutional neural network, respectively, for training to obtain the pressure field prediction model and the saturation field prediction model, and main parameters in the first training data sets include the basic static data, the large number of parallel examples, and the corresponding pressure field and saturation field obtained by forward modeling. The second training data set is used as an input to the long short-term memory neural network for training to obtain the injection-production performance prediction model, and the second training data set mainly includes the corresponding pressure field, saturation field and injection-production performance obtained by forward modeling, and acquired historical well control parameters.

Throughout the training process, a loss function is minimized by adjusting a parameter θ of the neural network. The gradient of the loss function with respect to θ is calculated by back propagation of a deep neural network. Optimization is performed using an adaptive moment estimation (ADAM) optimization algorithm, which is an optimization algorithm that may replace a traditional stochastic gradient descent (SGD) process, and weights of the neural network are iteratively updated based on the training data. The specific training time for recurrent neural networks depends on many factors, such as the size of a training set, the batch size, optimizer settings, the learning rate, and GPU performance. Although the training time may vary from case to case, the training time is very short compared to the time required for numerical modeling in a reservoir historical fitting process. Several important hyper-parameters such as the learning rate, the batch size, the number of rounds of training iterations, and weights λ defined in the loss function need to be repeatedly adjusted in the training process. It is found through training that both networks may converge within 200 rounds, and saturation usually converges faster than pressure field training. Through numerical experiments, it was found that the training process after proper data preprocessing is less affected by the setting of hyper-parameter values. Therefore, the hyper-parameters obtained from this training may be used as initial settings for parameters of a new neural network.

In step 5, parameter estimation of a reservoir geological model is performed based on the prediction model by means of an intelligent optimization algorithm.

This step specifically includes: step 51, the reservoir geological model, reservoir well control parameters and actual injection-production performance are acquired;
step 52, the reservoir geological model is input into the pressure field prediction model to obtain a pressure field of a reservoir, and the reservoir geological model is input into the saturation field prediction model to obtain a saturation field of the reservoir;
step 53, the pressure field, the saturation field, and the reservoir well control parameters are input into the injection-production performance prediction model to obtain predicted injection-production performance;
step 54, a difference between the predicted injection-production performance and the actual injection-production performance is used as a loss function;
step 55, stochastic optimization is performed on parameters of the reservoir geological model by using a random maximum likelihood estimation algorithm and a mesh adaptive direct search algorithm; and
step 56, the reservoir geological model of a reservoir region is updated based on parameters corresponding to the minimization of the loss function.

More specifically, the reservoir well control parameters include: the water injection volume and water injection pressure of a water injection well, the fluid production volume of the producing well, etc. The reservoir geological model may be constructed according to previous well logging data, coring data, seismic data, etc., and the geological model includes a variety of static parameters that may reflect physical properties of the reservoir region, such as permeability and porosity, i.e., the static data of the corresponding data training set. The well control parameters may be set according to an actual oil production plan and other situations. It is easily conceivable for those skilled in the art to conduct geological modeling based on the logging data, coring data, seismic data, etc., and set the well control parameters according to the actual situations. Therefore, the steps of how to establish the geological model and how to set the well control parameters are not repeated herein.

However, in the actual application process, since the reservoir geological model may have certain errors in the establishment process during the actual injection-production performance prediction process, the parameters of the reservoir geological model may be modified according to the predicted injection-production performance and the actual injection-production performance of the reservoir, so that the accuracy of the reservoir geological model is ensured, and a basis is provided for the subsequent prediction process. More specifically, when the parameters of the reservoir geological model are modified, at least one type of the parameters are modified, so that a more accurate geological model is obtained based on historical data fitting, and an underground structure of the reservoir can be accurately understood.

Therefore, in step 52, the geological model is input into the pressure field prediction model to predict the pressure field of the reservoir region, and the geological model is input into the saturation field prediction model to obtain the saturation field of the reservoir region. Inputting the geological model into the field prediction models may also be understood as that the static parameters included in the geological model, such as the permeability and the porosity, are used as the input of the field prediction models to predict the pressure field and the saturation field of the reservoir region. In step 53, the predicted injection-production performance may be obtained by using the pressure field predicted through the pressure field prediction model, the saturation field predicted through the saturation field prediction model, and the well control parameters as the input of the trained injection-production performance prediction model. The actual injection-production performance recorded in the actual oil exploitation process is compared with the predicted injection-production performance for determination. If the difference between the predicted injection-production performance and the actual injection-production performance is less than or equal to a preset threshold, it means that the error between the two is small, the predicted injection-production performance is more accurate, and the geological model is not required to be modified. If the difference between the predicted injection-production performance and the actual injection-production performance is greater than the preset threshold, it means that the error between the two is large, the predicted injection-production performance is not accurate enough, and the input geological model (i.e. permeability, porosity, and other parameters) is defaulted to have a deviation with the actual permeability, porosity, and other parameters in the reservoir region. Therefore, the difference between the predicted injection-production performance and the actual injection-production performance is used as the loss function, stochastic optimization for the static parameters of the geological model is performed using the random maximum likelihood estimation algorithm and the mesh adaptive direct search algorithm, and finally, within the set number of iterations, the reservoir geological model is updated based on the static parameters corresponding to the minimization of the loss function in all iterations, so that the optimized reservoir geological model is obtained. The parameters, such as the permeability and the porosity, included in the optimized reservoir geological model are more in line with the distribution characteristics of the current reservoir region, so that a supportive basis can be provided for subsequent accurate prediction for the injection-production performance.

In addition, maximum likelihood estimation provides a way to evaluate the model parameters based on given observational data, i.e., “model determined, parameters unknown”. The goal of the random maximum likelihood (RML) algorithm is to find a set of model parameters that may maximize the posterior probability or minimize the objective function. The mesh adaptive direct search (MADS) algorithm solves the minimization problem and inverts the model parameters, and is a kind of derivative free optimization algorithm. The main idea of the algorithm is to divide each iteration into a search step and a probe step. The search step refers to performing global search in variable space and identifying all feasible regions containing local optima. The probe step refers to performing local search in the variable space, aiming to find an optimal solution precisely.

As shown in FIG. 4, taking oil recovery as an example of the injection-production performance, the reservoir geological model of the reservoir region is updated with comparative analysis results of oil recovery predicted and actual oil recovery in the past 350 months. In this implementation, taking July as an example: comparative analysis of the predicted injection-production performance and the actual injection-production performance in July is determined to be carried out. Firstly, based on the well logging data, the coring data and the seismic data of the reservoir region, the reservoir geological model is established to obtain the static parameters; the reservoir geological model is input into the field prediction models to predict the pressure field and the saturation field of the reservoir region; moreover, the well control parameters of the water injection well and the well control parameters of the producing well as well as the predicted pressure field and saturation field of the reservoir region in July are used as inputs to the injection-production performance prediction model to predict the injection-production performance in July; then the actual injection-production performance in July obtained after oil exploitation based on the same well control parameters of the water injection well and well control parameters of the producing well is acquired for comparison; if the difference between the predicted injection-production performance and the actual injection-production performance is less than or equal to the preset threshold, it means that the error between the two is small, and the geological model is not required to be modified; if the difference between the predicted injection-production performance and the actual injection-production performance is greater than the preset threshold, it means that the error between the two is large, and the geological model is required to be modified, that is, the static parameters of the geological model are randomly modified using the random maximum likelihood estimation algorithm and the mesh adaptive direct search algorithm, and input into the field prediction models to predict the pressure field of the reservoir region and the saturation field in the reservoir region; then the newly predicted pressure field, saturation field, well control parameters of the water injection well and well control parameters of the producing well are used as inputs to the injection-production performance prediction model to predict the injection-production performance, and the injection-production performance is saved and recorded; and iterative loops are sequentially performed until the number of iterations is reached, then the predicted injection-production performance is compared with the actual injection-production performance, and the static parameters corresponding to the minimization of the loss function, that is, the difference between the predicted injection-production performance and the actual injection-production performance being the smallest, are selected to update the geological model of the reservoir region, so the updated reservoir geological model is obtained, and subsequent prediction for the injection-production performance is performed based on the updated reservoir geological model. Through the above scheme, automatic fitting of the injection-production performance is performed instead of manual historical fitting, so that the research cycle can be shortened, the limitations of the method can be reduced, the uncertainty of prediction for reservoir development indexes can be reduced, the precision of reservoir heterogeneity characterization is significantly improved, oilfield development management and decision-making are effectively guided, and quantitative analysis of uncertainty is carried out.

### Embodiment 2

As shown in FIG. 5, an embodiment of the present disclosure further provides an automatic history fitting apparatus based on RU-Net and LSTM neural network models. The apparatus includes:
a mesh partitioning module 10 configured to perform mesh partitioning of a reservoir property model by means of well zoning;
a data set construction module 20 configured to construct a data training set;
a data processing module 30 configured to process sample data in the data training set;
a model building module 40 configured to train, based on the processed sample data, prediction models for predicting pressure, saturation distribution and injection-production performance; and
a parameter estimation module 50 configured to perform, based on the prediction models, parameter estimation of a reservoir geological model by means of an intelligent optimization algorithm.

### Embodiment 3

The present disclosure provides an electronic device. The electronic device includes a memory, a processor, and a computer program stored in the memory and able to run on the processor, and the processor, when executing the computer program, implements the automatic history fitting method based on RU-Net and LSTM neural network models described above.

### Embodiment 4

The present disclosure provides a machine-readable storage medium. The machine-readable storage medium stores instructions, and the instructions are used to cause a machine to execute the automatic history fitting method based on RU-Net and LSTM neural network models described above.

The optional implementations of the embodiments of the present disclosure are described in detail above in combination with the accompanying drawings. However, the embodiments of the present disclosure are not limited to the specific details of the above implementations. Within the scope of the technical concept of the embodiments of the present disclosure, a variety of simple modifications may be made to the technical solutions of the embodiments of the present disclosure, and these simple modifications all fall within the protection scope of the embodiments of the present disclosure.

In addition, it is to be noted that the specific technical features described in the above detailed description may be combined in any suitable way without contradiction. In order to avoid unnecessary repetition, various possible combination methods will not be described separately in the embodiments of the present disclosure.

Those skilled in the art can understand that all or part of the steps in the method for implementing the above embodiments may be completed by instructing relevant hardware through a program. The program is stored in a storage medium, and includes several instructions used to enable a single-chip microcomputer, a chip or a processor to execute all or part of the steps of the method described in the embodiments of the present application. The above storage medium includes a USB flash disk, a mobile hard disk, a read-only memory (ROM), a random access memory (RAM), a disk, a compact disc or other media capable of storing program codes.

In addition, various different implementations of the embodiments of the present disclosure may also be combined arbitrarily, and as long as the implementations do not violate the spirit of the embodiments of the present disclosure, the implementations should also be regarded as the contents disclosed in the embodiments of the present disclosure.

1. An automatic history fitting method based on RU-Net and LSTM neural network models, comprising:
step 1, performing mesh partitioning of a reservoir property model by means of well zoning:
generating, based on well location coordinates in the reservoir property model, a plurality of well control units bounded by a well control range of a single well reservoir;
step 2, constructing a data training set, comprising:
step 21, for each well control unit:
calculating an average value of each type of static parameters in all meshes comprised in the well control unit to obtain multiple types of average static parameters of the well control unit, and using the multiple types of average static parameters of all the well control units as basic static data;
step 22, performing parameter perturbation on the basic static data to generate a plurality of parallel examples as input data of the data training set; and
step 23, performing forward modeling on the generated plurality of parallel examples respectively through numerical modeling of the reservoir to obtain reservoir pressure, saturation distribution and injection-production performance as output data of the data training set;
step 3, processing sample data in the data training set;
step 4, training, based on the processed sample data, prediction models for predicting the reservoir pressure, the saturation distribution and the injection-production performance; and
step 5, performing, based on the prediction models, parameter estimation of a reservoir geological model by means of an intelligent optimization algorithm.

2. The method according to claim 1, wherein step 3 comprises:
step 31, cleaning the sample data based on a production history of a producing well, production performance of a peripheral well and reservoir physical property distribution;
step 32, rejecting outliers in the sample data; and
step 33, performing normalization processing on the sample data.

3. The method according to claim 2, wherein step 33 comprises:
step 331, for pressure field data in the sample data:
calculating an average value of pressure fields of all time steps in the sample data;
subtracting the average value of the pressure fields of all the time steps from pressure field data of each time step to obtain a pressure difference field; and
performing normalization processing on the pressure difference field by using a min-max normalization algorithm; and
step 332, performing normalization processing on all other data in the sample data except the pressure fields by using the min-max normalization algorithm.

4. The method according to claim 1, wherein step 4 comprises:
step 41, training, based on the processed sample data and a recursive full convolutional neural network, to obtain a pressure field prediction model and a saturation field prediction model; and
step 42, training, based on the processed sample data and a long short-term memory neural network, to obtain an injection-production performance prediction model.

5. The method according to claim 4, wherein step 5 comprises:
step 51, acquiring the reservoir geological model, reservoir well control parameters and actual injection-production performance;
step 52, inputting the reservoir geological model into the pressure field prediction model to obtain a pressure field of a reservoir, and inputting the reservoir geological model into the saturation field prediction model to obtain a saturation field of the reservoir;
step 53, inputting the pressure field, the saturation field, and the reservoir well control parameters into the injection-production performance prediction model to obtain predicted injection-production performance;
step 54, using a difference between the predicted injection-production performance and the actual injection-production performance as a loss function;
step 55, performing stochastic optimization on parameters of the reservoir geological model by using a random maximum likelihood estimation algorithm and a mesh adaptive direct search algorithm; and
step 56, updating the reservoir geological model of a reservoir region based on parameters corresponding to the minimization of the loss function.

6. An automatic history fitting apparatus based on RU-Net and LSTM neural network models, comprising:
a mesh partitioning module configured to perform mesh partitioning of a reservoir property model by means of well zoning: generating, based on well location coordinates in the reservoir property model, a plurality of well control units bounded by a well control range of a single well reservoir;
a data set construction module configured to construct a data training set, comprising:
for each well control unit:
calculating an average value of each type of static parameters in all meshes comprised in the well control unit to obtain multiple types of average static parameters of the well control unit, and using the multiple types of average static parameters of all the well control units as basic static data;
performing parameter perturbation on the basic static data to generate a plurality of parallel examples as input data of the data training set; and
performing forward modeling on the generated plurality of parallel examples respectively through numerical modeling of the reservoir to obtain reservoir pressure, saturation distribution and injection-production performance as output data of the data training set;
a data processing module configured to process sample data in the data training set;
a model building module configured to train, based on the processed sample data, prediction models for predicting the pressure, the saturation distribution and the injection-production performance; and
a parameter estimation module configured to perform, based on the prediction models, parameter estimation of a reservoir geological model by means of an intelligent optimization algorithm.

7. The apparatus according to claim 6, wherein the data processing module is specifically configured to:
clean the sample data based on a production history of a producing well, production performance of a peripheral well, and reservoir physical property distribution;
reject outliers in the sample data; and
perform normalization processing on the sample data.

8. The apparatus according to claim 6, wherein the model building module is specifically configured to:
train, based on the processed sample data and a recursive full convolutional neural network, to obtain a pressure field prediction model and a saturation field prediction model; and
train, based on the processed sample data and a long short-term memory neural network, to obtain an injection-production performance prediction model.

9. (canceled)

10. A machine-readable storage medium storing instructions, wherein the instructions are used to cause a machine to execute an automatic history fitting method based on RU-Net and LSTM neural network models according to claim 1.
